(19) United States
(12) Patent Application Publication
(10) Pub. No.: US 2004/0223806 A1
(43) Pub. Date: Nov. 11, 2004

(54) Fastening system for a patient table

(76) Inventor: Matthias Seufert, Oberreichenbach (DE)

Correspondence Address: Brinks Hofer Gilson & Lione, P.O. Box 10395, Cicago, IL, 60610, US

(21) Appl. No.: 10/807,981

(22) Filed: Mar. 24, 2004

(30) Foreign Application Priority Data
Mar. 27, 2003 (DE) 10313899.4

(51) Int. Cl. F16D 1/00

(52) U.S. Cl. 403/317

(57) ABSTRACT

A fastening device for fastening an object on a patient table comprises a horizontally extending recess provided on at least one longitudinal side of the patient table and a bracket arranged on the object to be fastened. The bracket can be engaged with this recess. The recess is designed in such a way that the bracket whose shape is suitably adapted to the recess can be inserted with minimal frictional resistance into the recess in a substantially traversal direction to the longitudinal of the extent of the recess to establish a force-fitting and/or form-fitting engagement of the bracket with the recess. For a straightforward and systematic establishment of the engagement, an upper inside wall of the recess can extend upwardly toward a back of the recess, and a portion of the bracket is adapted to substantially engage with the upper inside wall of the recess toward the back wall of the recess. The upper inside wall of the recess can have a groove adapted to engage a lug of the bracket.

### BACKGROUND

The invention relates, in general, to clinical patient tables, and more particularly to a fastening system for fastening an object or an accessory on a patient table.

Patient tables are typically used for supporting patients in clinical working environments. Patient tables can be moveable or be fixed in a position and can satisfy a very wide variety of requirements, e.g. adaptation to different procedures for obtaining diagnostic images. Typically, versatility and ease of use tend to drive desirable designs of patient tables. On one hand, the desired versatility may facilitate a plurality of usages of patient tables with different clinical devices and, on the other hand, may satisfy requirements to patient-specific pathological diagnostics, monitoring or treatments.

To increase their versatility, patient tables may have fastening devices on which or to which a very wide variety of accessories can be fastened; for example an infusion set, a control device for a procedure, or a monitoring unit for monitoring a physiological parameter of the patient.

EP 0 752 237 B1 discloses a device for fastening surgical operating instruments on a patient table utilizing rails which are secured to the patient table. As such, operating instruments and accessories can be fastened exchangeably on the rails. However, this device has a disadvantage in that the fastening rails protrude from the patient table and therefore restrict access to the patient table and/or to the patient, and also introduce an elevated probability for collisions. In addition, because of their problematic edges and/or protrusions, the rails represent an undesirable source for errors, such as errors in X-ray images. Further, an arrangement of accessories and clinical and/or operating instruments on the rails is also made difficult because a desirably stable attachment or engagement is obtained only when the accessory has either been fitted on and then screwed to the rail or has been pushed onto the rails from one end thereof and engaged with the rail in a substantially tight, form-fitted engagement. In particular, an automatic or systematic establishment of the engagement is only possible by introducing the accessory in a direction of an extent of the rail, and not transversely or perpendicularly thereto.

### OBJECT AND SUMMARY

The present invention is defined by the following claims. This description summarizes some aspects of the present embodiments and should not be used to limit the claims.

An object of the invention is to provide a device for fastening accessories on patient tables, and facilitate straightforward attachment of the accessories at any desired position on or along the fastening device, while minimizing a probability for collisions and reducing problematic interferences that, for example, may adversely affect a quality of desirable X-ray images.

One concept of the invention is to disclose a fastening system for fastening an object on a patient table. The fastening system includes a fastening device in which a horizontally extending recess is provided on the patient table. The recess may be designed in such a way that a bracket suitably adapted to a shape of the recess can be inserted without resistance into the recess in a direction of insertion independently of the direction of the extent of the recess, e.g. transversely or perpendicularly thereto. Once inserted into the recess, the bracket can be adaptively lodged or affixed in place via a force-fitting and/or form-fitting engagement.

The recess may allow or facilitate an insertion of a suitable bracket in a direction of insertion independently of the direction of the extent of the recess, the bracket can be inserted at any desired position along a length of the recess and may not need to be pushed in from either ends of the recess. With the resistance-free insertion of the bracket, no mechanical resistance may have to be overcome and no lock position may have to be reached or attained. As such, typical accessories can easily be inserted without force and without jolting, which is advantageous in particular for accessories which are sensitive to jolting. Upon lodging in the recess, a force-fitting and/or form-fitting engagement is automatically or systematically established, which may make handling easier and may render unnecessary additional connections, attachments or engagements, e.g. screw connections. The easy and straightforward handling may substantially facilitate rapid fittings of different accessories for adaptation to particular circumstances or needs and to particular patients, insofar as these accessories are equipped with a suitably adapted fastening bracket.

In an advantageous embodiment of the invention, an upper inside wall of the recess has an area which extends upwardly in a direction toward a back of the recess—a cross section of the recess may widen toward the upper inside wall. A portion of a bracket may be adapted to substantially match or follow a course, profile or a contour line of the upper inside wall and likewise extend upward to be inserted into this area. As such, the corresponding accessory may be secured against inadvertent withdrawal from the recess, and subsequently a substantially stable engagement is obtained. Due to the upward course of the bracket and of the upper inside wall of the recess, the corresponding accessory can in fact be withdrawn only while being simultaneously lifted so that the bracket can leave the upwardly extending area of the recess. At the same time, lodging the bracket in a correspondingly shaped recess may be easy to accomplish and may not need to be specifically explained to an operator or a user.

In a further advantageous embodiment of the invention, the recess may have a groove into which a lug, handle or hook of a fastening bracket may be adaptively inserted. The fastening bracket brought into engagement with the groove is thus additionally secured against inadvertent withdrawal of the bracket or the corresponding accessory. To move the lug of the fastening bracket out of the groove, the accessory may be moved in a deliberate manner. At the same time, the lug of the fastening bracket can be brought into engagement with the groove without any special handling being required. In addition, one advantage is that the engagement of the lug into or with the groove when lodging an accessory into the recess can be felt or physically noticed, thus providing increased control when lodging the accessory in place.

Another concept of the invention relates to specifying a bracket for fastening an object on a patient table, the fastening device having a recess with a shape described above. A shape of the bracket is adapted to the shape of the recess in such a way that the bracket can be inserted without resistance into the recess in a direction of insertion independently of the direction of the extent of the recess. Once introduced into the recess, the bracket can be lodged automatically or systematically with a force-fitting and/or form-fitting engagement. An accessory equipped with such a bracket can be lodged in the recess at any desired position of said recess without specific handlings or maneuverings.

In a still further advantageous embodiment of the invention, the bracket may have a lock. The bracket lock may have a spring mechanism that may additionally secure the bracket to the fastening device, once lodged in the recess, in such a way that the force-fitting and/or form-fitting bracket engagement with the recess is additionally strengthened. The lock may provide additional securing of the engagement of the lodged accessory with the patient table while being easy to control or handle since spring mechanisms may be designed to be operated with minimal manual maneuverings, e.g. involving a catch mechanism. Depending on the accessory to be lodged in place, the lock can be provided specifically for an accessory which may need additional securing, whereas an accessory which does not require additional securing may be left without a lock.

In a still further advantageous embodiment of the invention, the bracket may have a lock which, after a lodging of the bracket and establishment of a form-fitting engagement with the recess, can be activated in order to block undesirable movements of the bracket which may cancel or disrupt the form-fitting bracket engagement with the recess. Such a lock may also be easy to produce or manufacture, e.g. when involving a catch mechanism, and straightforward to handle. Further, the lock may provide a desirably reliable securing for an accessory which particularly requires such securing.

Further advantageous features are the subject of the dependent claims.

Illustrative and exemplary embodiments of the invention are described in further detail below with reference to and in conjunction with the figures.

### BRIEF DESCRIPTION OF THE DRAWINGS

FIG. 1 is a cross-sectional view of a fastening system with a fastening device having a recess and a bracket; and

FIG. 2 is a perspective view of a patient table shown with the fastening system of FIG. 1 and accessories secured to the fastening system.

### DESCRIPTION OF THE PREFERRED EMBODIMENTS

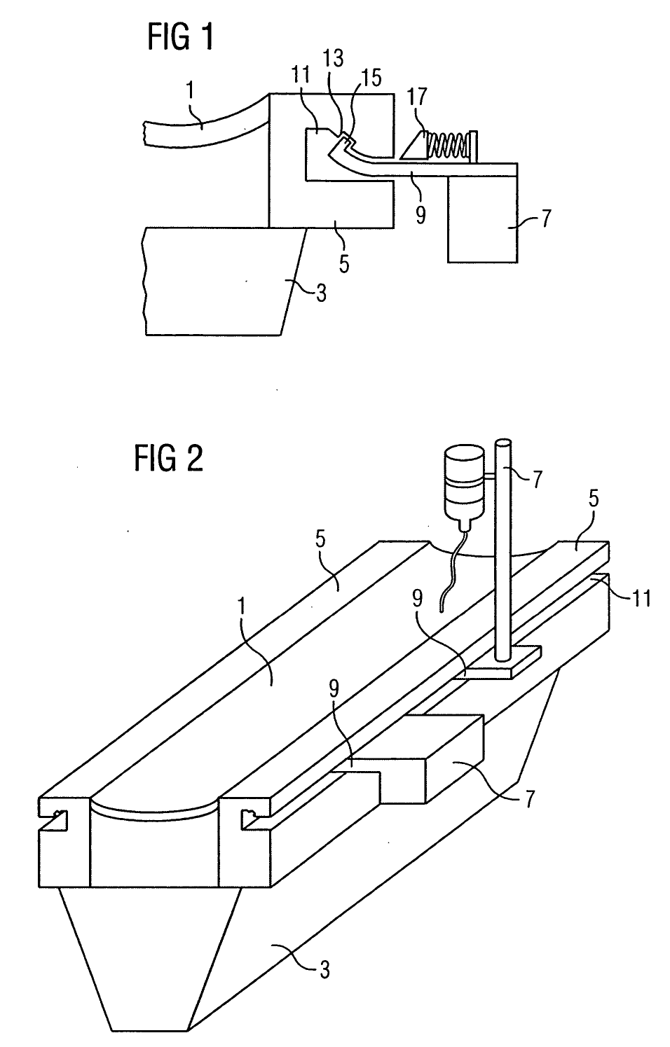

A fastening system 2 according to the invention, having a fastening device with a recess 11 and a bracket 9, is shown in a cross-sectional view in FIG. 1. The fastening device 2 is part of or integral to a patient table 1 which stands on a base 3. The patient table 1 has a side panel 5 in which the fastening device 2 is formed or integrated.

On each side of the patient table 1, the fastening device 2 may provide the recess 11. The recess 11 has a sufficiently wide opening to ensure that a bracket 9 whose shape is adapted to the recess 11 can be inserted into the recess 11 in a direction of insertion independently of the direction of an extent of the recess 11, e.g. transversely or perpendicularly thereto. The sufficiently wide opening of the recess 11 may be defined by a bottom edge 16 and an opposite top edge 18. The opening may be wide enough to ensure that a correspondingly shaped bracket 9 can be inserted without applying a pushing force to overcome any resistance.

In an inner area of the recess 11, the upper inside wall 12 extends upwardly toward a back 14 of the recess 11. As shown in FIG. 1, an upward widening of the recess 11 may result. The bracket 9, which is arranged on an accessory or object 7, has a handle-like portion 10 adaptively shaped to a course of the upper inside wall 12 of the recess 1. Thus, the bracket 9 may curve upward as the portion 10 extends away from the object 7 and into the recess 11.

When the object 7 is affixed via the bracket 9 to the recess 11, the portion 10 of the bracket 9 lying in the recess 11 is forced or pushed upward, by a weight of the object 7, with the bottom edge 16 as the pivot point. As such, the upwardly curved portion 10 of the bracket 9 bears against the upwardly extending area of the upper inside wall 12 of the recess 11. Due to the bracket 9 bearing on the upper inside wall 12 on account of the weight of the object 7, a frictional force may be created between surfaces of the bracket and the upper and lower edges of the opening of the recess 11. Thus, a force-fitting engagement between the bracket 9 and the recess 11 is provided. This force-fitting engagement may ensure that the bracket 9 and thus also the object 7 may not inadvertently withdraw from the mutual engagement.

In addition, the upward course of the upper inside wall 12 and of the portion 10 of the bracket 9 may establish a form-fitting engagement, thereby securing against inadvertent withdrawals. In order to uncouple or disengage the object 7, the object 7 cannot be pulled out straightforwardly, but instead may have to be lifted until the upwardly curved portion 10 of the bracket 9 drops or is sufficiently lowered to be able to pass through and exit the opening of the recess 11. Therefore, a form-fitting engagement with respect to the horizontal withdrawal of the object 7 may be obtained which, depending on the mutual shapes of the recess 11 and bracket 9, can be substantially more stable than the force-fitting engagement. Further, the form-fitting engagement can be easily established by and asserted an operator via an insertion of the bracket 9 through the opening of the recess 11 and subsequently into recess 11.

To additionally secure the bracket 9, the recess 11 may have a groove 13 formed in the upper inside wall 12. A lug or hook 15 formed near an end part of the bracket 9 can be adaptively engaged in the groove 13. The groove 13 and the lug 15 may both have a rectangular profile so that they can be brought into engagement with one another without applying an additional pushing force to overcome a corresponding frictional resistance. The engagement of the lug 15 with the groove 13 may likewise be established in a form-fitting fashion with a substantially improved stability. To release this engagement, the lug 15 of the bracket 9 may first have to be lowered, by lifting the object 7, until the lug 15 is moved completely out of the groove 13. Consequently, a horizontal movement or pass of the bracket 9 through the recess 11 may be rendered possible only when the lug 15 is completely disengaged from the groove 13.

Further, the form-fitting engagement of the lug 15 and the groove 13 may be optimized when their respective edges mutually extend at an inclined angle, i.e. neither vertically and nor perpendicularly with respect to the movement of withdrawal of the bracket 9 from the recess 11. Further, the engagement of the lug 15 with the groove 13 may be strengthened by a potential horizontal withdrawal movement of the bracket 9 from the recess 11, which leads the lug 15 to be pressed further or deeper into the groove 13 along their respective edges situated toward the opening of the recess 11. The above described mutually matching configuration of the lug 15 and of the groove 13 may provide an increased securing and stabilization of their mutual engagement. In addition, the engagement of the lug 15 with the groove 13 can be felt by an operator, thus improving the handling and the maneuverings of the bracket.

Still further, the bracket 9 can have a lock 17 which can be activated when the bracket 9 is in a lodged position within the recess 11. The lock can have a spring mechanism which, as in the manner described above, uses the engagement of the lug 15 in the groove 13 to further stabilize the engagement of the bracket 9 with the recess 11. For this improved stabilization, the lock 17 may act on the bracket 9 with a biasing force directed away from the recess 11. As such, the mutual engagement of the lug 15 with the groove 13 may be strengthened.

Moreover, the lock 17 can be wedge-shaped in order to effect a clamping action of the bracket 9 in the opening of the recess 11. Such a lock mechanism can be pre-stressed to counter a spring force by using a simple catch mechanism and can be activated by unlocking the spring mechanism. The lock 17 may be easy to operate and can be activated with one hand while lodging the object 7 in place.

Instead of a mechanism based on spring force, the lock 17 can also be a rigid lock which blocks potential movements which may cancel the mutual engagement between the lug 15 and the groove 13. Since the mutually bearing edges of the lug 15 and the groove 13 may not extend perpendicularly with respect to the withdrawal movement of the bracket 9 from the recess 11, the bracket 9 may first have to be pushed deeper into the recess 11 in order to dislodge the lug 15 and to release their mutual engagement. The lock 17 therefore may simply have to suppress or reduce the deeper insertion of the bracket 9 into the recess 11. For this purpose, as shown diagrammatically in FIG. 1, the spring mechanism can include a clamping lever which can be locked and released by simply turning it and may therefore be operated with just one movement.

Referring now to FIG. 2, a perspective representational view of a patient table 1 is shown with a fastening system 2 according to an embodiment of the invention. The patient table 1 likewise has a base 3 and a side panel 5. The fastening system may be integrated on one or both sides of the patient table 1 into the side panel 5.

As described above with reference to the preceding FIG. 1, the patient table 1 has a side panel 5 in which the fastening system 2 is formed and integrated. The fastening system 2 may include the recess 11 to engage with the bracket 9. Accessories or objects 7 can be secured via the bracket 9 to the recess 11. An infusion set and a control panel are shown here as examples of objects 7. As shown in FIG. 2, the recess 11 may extend along a longitudinal axis of the patient table 1 and that objects 7 can be affixed or secured at any desired position along the recess 11 in the longitudinal direction.

The respective ends of the recess 11 located at either longitudinal end of the patient table 1 may not be open, so as to ensure that the objects 7 do not inadvertently slide out of the recess 11. In addition, the frontal opening of the recess 11 can also be suitably protected to prevent soiling.

The fastening system 2 according to the invention has an advantage that no protruding objects and other problematic edges are formed on the patient table 1. This configuration of the fastening system 2 on the patient table 1 may on one hand minimize a risk of collision with the patient table 1 and, on the other hand, reduce sources of X-ray image errors, typically caused for example other objects or by part attachments positioned on the patient table 1. If the patient table 1 is to be suited for use with radiography equipment, for example, the outer and inner edges of the fastening device, and of the recess 11, can also be rounded, because rounded edges have less potential to interfere with X-ray images than do sharp edges. In addition, rounded edges may even entail a lower risk or probability for collisions and injuries.

1. A fastening system for fastening an object on a patient table, the fastening system comprising:
a fastening device having a horizontally extending recess provided on at least one longitudinal side of the patient table; and
a bracket adaptively shaped to engage with the recess,
wherein the bracket is insertable into the recess in a substantially traversal direction to the longitudinal extent of the recess with minimal frictional resistance to establish a force-fitting engagement.

2. A fastening system for fastening an object on a patient table, the fastening system comprising:
a horizontally extending recess provided on at least one longitudinal side of the patient table; and
a bracket adaptively shaped to engage with the recess,
wherein the bracket is inserted into the recess in a substantially traversal direction to the longitudinal extent of the recess with minimal frictional resistance to establish a form-fitting engagement.

3. The fastening system as in claim 1, wherein an upper inside wall of the recess extends upwardly toward a back wall of the recess, and a portion of the bracket is adapted to substantially engage with the upper inside wall of the recess toward the back wall of the recess.

4. The fastening system as in claimed 3 wherein an upward widening of the recess is formed toward the back wall of the recess.

5. The fastening system as in claimed 3 wherein the upper inside wall of the recess has a groove which extends in a parallel direction to the longitudinal of extent of the recess, and the bracket has a lug adapted to engage with the groove with minimal frictional resistance.

6. The fastening system as in claimed 3 wherein a the bracket is suitably shaped to accommodate an insertion of the bracket in the recess with minimal frictional resistance in a substantially traverse direction to the longitudinal direction of the recess to establish a force-fitting engagement between the recess and the bracket.

7. The fastening system as in claimed 3 wherein a the bracket is suitably shaped to accommodate an insertion of the bracket in the recess with minimal frictional resistance in a substantially traverse direction to the longitudinal direction of the recess to establish a form-fitting engagement between the recess and the bracket.

8. The fastening system as in claim 6, wherein a locking mechanism biases the bracket away from the recess via a spring to strengthen the force-fitting engagement of the bracket with the recess.

9. The fastening system as in claim 7, wherein a locking mechanism biases the bracket away from the recess via a spring to strengthen the form-fitting engagement of the bracket with the recess.

10. The fastening system as in claim 6, wherein the locking mechanism minimizes inadvertent disengaging movements of the bracket out of the form-fitting engagement of the bracket with the recess.

11. The fastening system as in claim 7, wherein the locking mechanism minimizes inadvertent disengaging movements of the bracket out of the force-fitting engagement of the bracket with the recess.

12. In an improvement of a bracket for fastening an object on a patient table with a suitably designed recess, the improvement comprising the shape of the bracket being adapted to the recess in such a way that the bracket can be inserted without resistance into the recess in a direction of insertion independent of the direction of extent of the recess and can be lodged in the recess with automatic establishment of a force-fit and/or form-fit connection.

13. The improvement of claim 12 wherein the bracket has a lock which can be acted upon with a spring force.

14. The improvement of claim 13 wherein the bracket has a lock which is operable to block a movement of the bracket out of the form-fit connection with the recess.
